(19) United States
(12) Patent Application Publication
(10) Pub. No.: US 2011/0237266 A1
(43) Pub. Date: Sep. 29, 2011

(54) Sounding Reference Signal Transmission During Discontinuous Reception

(75) Inventor: Zhijun Cai, Euless, TX (US)

(73) Assignee: Research In Motion Limited, Waterloo (CA)

(21) Appl. No.: 12/732,627

(22) Filed: Mar. 26, 2010

(51) Int. Cl. H04W 72/00

(52) U.S. Cl. 455/450

(57) ABSTRACT

A method implemented by a user equipment (UE). An indicator is read. One or more sounding reference signals (SRS) are not reported when the indicator is set to “true” and an On Duration Timer associated with a discontinuous reception (DRX) cycle is not running. One or more SRS are not reported when the indicator is not set to “true” and the UE is not in active time during the DRX cycle.

### BACKGROUND

As used herein, the terms “user equipment” (“UE”), “mobile station” (“MS”), and “user agent” (“UA”) might in some cases refer to mobile devices such as mobile telephones, personal digital assistants, handheld or laptop computers, and similar devices that have telecommunications capabilities. The terms “MS,” “UE,” “UA,” “user device,” and “user node” may be used synonymously herein. A UE might include components that allow the UE to communicate with other devices, and might also include one or more associated removable memory modules, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might be the device itself without such a module. In other cases, the term “UE” might refer to devices that have similar capabilities but that are not readily transportable, such as desktop computers, set-top boxes, or network appliances. The term “UE” can also refer to any hardware or software component that can terminate a communication session for a user.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as Long-Term Evolution (LTE) and LTE-Advanced (LTE-A). For example, an LTE or LTE-A systems and devices might include an Evolved Universal Terrestrial Radio Access Network (E-UTRAN) which may include an E-UTRAN node B (or eNB), a Home E-UTRAN node B (HeNB), a relay node, or a similar component rather than a traditional base station. These and similar components may be referred to as access nodes. Other components, for example in UTRAN, WLAN or WiMAX, that may be referred to as access nodes, may include a node B (NB), evolved node B (eNB), Home node B (HNB) or a wireless access point. The term “(e)NB” may contemplate NBs and eNBs.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an example of a DRX cycle, according to an embodiment of the present disclosure.

FIG. 2 illustrates an example of a DRX cycle including the operation of certain timers, according to an embodiment of the present disclosure.

FIG. 3 illustrates a periodic SRS transmission scheme, according to an embodiment of the present disclosure.

FIG. 4 is a flowchart of a process for indicating how SRS are transmitted during DRX, according to an embodiment of the present disclosure.

FIG. 5 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

As used throughout the specification, claims, and Figures, the following acronyms have the following definitions. Some of the terms identified below are defined by and follow the standards set forth by the Third Generation Partnership Program (3GPP) technical specifications. Where the 3GPP technical specifications use a term using the same acronym or words as those presented below, the 3GPP technical specifications describe the definition and functions of the corresponding term. However, the embodiments described herein use these components and/or functions according to inventive techniques described herein. Possibly, not all of the following terms are described in the 3GPP specifications.

“CQI” is defined as “Channel Quality Indicator.”

“C-RNTI” is defined as “Cell Radio Network Temporary Identifier (RNTI).”

“DL” is defined as “Downlink.”

“DRX” is defined as “Discontinuous Reception.”

“DwPTS” is defined as “Downlink Pilot Time Slot.”

“eNB” is defined as “E-UTRAN Node B.”

“E-UTRA” is defined as “Evolved UMTS Terrestrial Radio Access.”

“E-UTRAN” is defined as “Evolved UMTS Terrestrial Radio Access Network.”

“FDD” is defined as “Frequency Division Duplexing.”

“HARQ” is defined as “Hybrid ARQ (Automatic Repeat Request).”

“ID” is defined as “Identity” or “Identifier.”

“LTE” is defined as “Long Term Evolution.”

“MAC” is defined as “Media Access Control.”

“ms” is defined as “milliseconds.”

“NDI” is defined as “New Data Indicator.”

“PDCCH” is defined as “Physical Downlink Control Channel.”

“PDSCH” is defined as “Physical Downlink Shared Channel.”

“PUCCH” is defined as “Physical Uplink Control Channel.”

“PUSCH” is defined as “Physical Uplink Shared Channel.”

“PMI” is defined as “Precoding Matrix Index.”

“RI” is defined as “Rank Indicator.”

“RNTI” is defined as “Radio Network Temporary Identifier.”

“RRC” is defined as “Radio Resource Control.”

“RTT” is defined as “Round Trip Time.”

“RV” is defined as “Redundancy Version.”

“SCH” is defined as “Shared Channel.”

“SFN” is defined as “Single Frequency Network.”

“SRS” is defined as “Sounding Reference Signal.”

“TB” is defined as “Transport Block.”

“TTI” is defined as “Transmission Time Interval.”

“TPC-PUCCH-RNTI” is defined as “Transmit Power Control-Physical Uplink Control Channel-RNTI.”

“TPC-PUSCH-RNTI” is defined as “Transmit Power Control-Physical Uplink Shared Channel-RNTI.”

“UL” is defined as “Uplink.”

As used herein, the following terms have the following definitions.

The term “may,” in some embodiments, might refer to either a requirement or an option to perform an activity depending on the implementation and other factors. Thus, for example, the statement “the UE may place a call” could mean “the UE will place a call,” “the UE shall place a call,” or “the UE might optionally place a call,” with any one of these meanings being potentially applicable depending on the implementation of a particular embodiment.

“Active time” is the time related to DRX operation, as defined in subclause 5.7 of 3GPP TS 36.321, during which the UE monitors the PDCCH in PDCCH subframes.

The “DRX cycle” specifies the periodic repetition of the on duration followed by a possible period of inactivity.

The “DRX Inactivity Timer” is a timer that specifies the number of consecutive PDCCH subframes after successfully decoding a PDCCH indicating an initial UL or DL user data transmission for the UE.

The “DRX Retransmission Timer” is a timer that specifies the maximum number of consecutive PDCCH subframes before a DL retransmission is expected by the UE.

The “DRX Short Cycle Tinier” is a timer that specifies the number of consecutive subframes the UE may follow the short DRX cycle.

The “DRX Start Offset” specifies the subframe where the DRX cycle starts.

“HARQ information” may include a NDI and a TB size. For DL SCH transmissions, the HARQ information may also include a HARQ process ID. For UL SCH transmissions, the HARQ information may also include a RV. In the case of spatial multiplexing on the DL SCH, the HARQ information may include a set of NDI and TB sizes for each transport block.

The “HARQ RTT Timer” is a timer that specifies the minimum amount of subframes passing before a DL HARQ retransmission is expected by the UE.

The “On Duration Timer” is a timer that specifies the number of consecutive PDCCH subframes at the beginning of a DRX cycle.

A “PDCCH subframe,” for FDD UE operation, represents any subframe. For TDD, the “PDCCH subframe” may only represent downlink subframes and subframes including DwPTS.

In view of these definitions, the embodiments may be more readily understood. The embodiments relate to transmission of SRS in a manner which may in some embodiments be more efficient for UEs that are capable of DRX operation. Previously, during DRX a UE might not report SRS when not in active time. However, this rule may not provide the desired efficiency for reporting of SRS. As a result of the current rule, because a UE can send SRS whenever it is active, a UE might report SRS unnecessarily. Furthermore, this result may not provide an eNB an efficient way of time-sharing limited SRS resources between users in DRX.

The embodiments described herein provide for limiting SRS transmission during the active time of a DRX cycle. Limiting SRS transmission during active time conserves the UE's battery power and allows for sharing of uplink SRS resources, which may be more efficient in some embodiments. One mechanism for limiting SRS transmission during the active time of a DRX cycle is to avoid reporting SRS if some indicator, such as a CQI mask, is set to “true” and if an “On Duration Timer” is not running. Alternatively, if the indicator is not set to “true,” such as being set to “false,” then SRS transmission may be reported when not the active time. These embodiments are described further below.

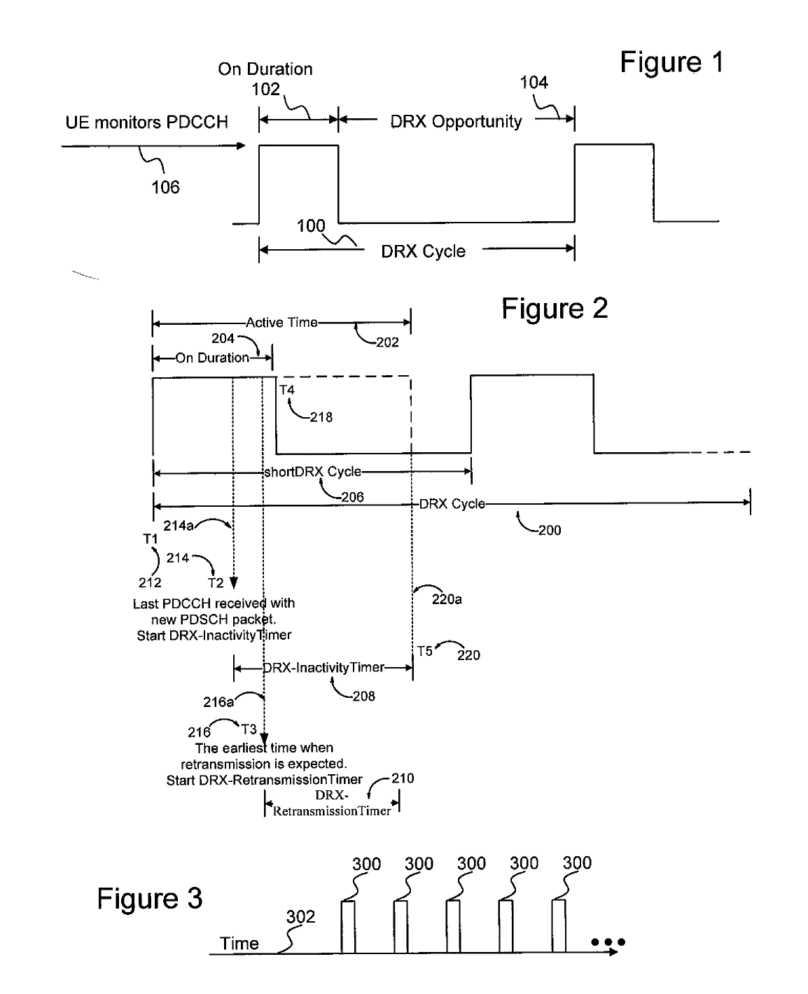

FIG. 1 illustrates an example of a DRX cycle, according to an embodiment of the present disclosure. As defined above, DRX cycle 100 specifies the periodic repetition of an “on duration” 102 followed by a possible period of inactivity, identified by “DRX opportunity” 104 in FIG. 1. During the on duration 102, the UE monitors the PDCCH, as shown at arrow 106.

In LTE release 8 and release 9, the UE may be configured by the RRC with a DRX functionality that controls the UE's PDCCH monitoring activity for the UE's C-RNTI, TPC-PUCCH-RNTI, TPC-PUSCH-RNTI and Semi-Persistent Scheduling C-RNTI (if configured). When in RRC_CONNECTED, if DRX is configured, the UE may be allowed to monitor the PDCCH discontinuously using the DRX operation. Otherwise, the UE may monitor the PDCCH continuously.

The RRC may control DRX operation by configuring one or more timers. Examples of such timers include an On Duration Timer, a DRX Inactivity Timer, a DRX Retransmission Timer, a long DRX Cycle, and the DRX Short Cycle Timer. The RRC may further control DRX operation by changing the values of the DRX Start Offset and the short DRX Cycle. A HARQ RTT Timer per DL HARQ process also may be defined, except for the broadcast process. These timers and values are shown in FIG. 2.

When a DRX cycle is configured, the active time may include the time while four, possibly more or fewer, activities are ongoing. First, the active time may include the time while the On Duration Timer, DRX Inactivity Timer, DRX Retransmission Timer, or MAC Contention Resolution Timer is running. Second, the active time may include the time while a scheduling request is sent on the PUCCH and is pending. Third, the active time may include the time while an uplink grant for a pending HARQ retransmission can occur and there is data in the corresponding HARQ buffer. Fourth, the active time may include the time while a PDCCH indicating a new transmission addressed to the C-RNTI of the UE has not been received after successful reception of a random access response for the preamble not selected by the UE. The active time may also include more or fewer or different activities.

When DRX is configured, the UE may take, for each subframe, one of a variety of actions. Several possible actions are described below, though not all actions need be taken, and more or fewer actions may be available.

In an embodiment, if the Short DRX Cycle is used and [(SFN * 10)+subframe number] modulo (short DRX Cycle)=(DRX Start Offset) modulo (short DRX Cycle); or if the Long DRX Cycle is used and [(SFN * 10)+subframe number] modulo (long DRX Cycle)=DRX Start Offset, then the On Duration Timer may be started.

In an embodiment, if a HARQ RTT Timer expires in this subframe and the data in the soft buffer of the corresponding HARQ process was not successfully decoded, then the DRX Retransmission Timer may be started for the corresponding HARQ process.

In an embodiment, if a DRX Command MAC control element is received, then the On Duration Timer may be stopped, and the DRX Inactivity Timer may be also stopped. In an embodiment, if the DRX Inactivity Timer expires or a DRX Command MAC control element is received in this subframe, then if the Short DRX cycle is configured the DRX Short Cycle Timer may be started or restarted and the Short DRX Cycle may be used. Otherwise, the Long DRX cycle may be used. In an embodiment, if the DRX Short Cycle Timer expires in this subframe, then the Long DRX cycle may be used.

In an embodiment, during the active time, for a PDCCH subframe, if the subframe is not required for uplink transmission for half-duplex FDD UE operation and if the subframe is not part of a configured measurement gap, then the PDCCH may be monitored. Additionally, if the PDCCH indicates a DL transmission or if a DL assignment has been configured for this subframe, then the HARQ RTT Timer may be started for the corresponding HARQ process and also the DRX Retransmission Timer may be stopped for the corresponding HARQ process. Furthermore, if the PDCCH indicates a new transmission (DL or UL), then the DRX Inactivity Timer may be started or restarted.

In an embodiment, the SRS may not be reported in certain circumstances. In an embodiment, if the CQI-Mask is set to “true,” then when the On Duration Timer is not running, the SRS and CQI/PMI/RI on the PUCCH may not be reported. Otherwise, when the CQI-Mask is not “true,” such as being set to “false,” then when not in active time the SRS and CQI/PMI/RI on the PUCCH may not be reported. In an embodiment, regardless of whether the UE is monitoring the PDCCH, the UE may receive and transmit HARQ feedback when such information is expected.

FIG. 2 illustrates an example of a DRX cycle including the operation of certain timers, according to an embodiment of the present disclosure. FIG. 2 is similar to FIG. 1, but includes additional details. DRX cycle 200 includes the active time 202, the short DRX cycle 206, the DRX Inactivity Timer 208, and the DRX Retransmission Timer 210. The active time might extend past the on duration 204.

At time T1 212, which is at the boundary of the DRX cycle, the On Duration Timer may be started. Prior to the expiration of the On Duration Timer at time T2 214, shown at phantom arrow 214a, a new PDSCH packet may have been sent by the eNB to the UE. The DRX Inactivity Timer 208 may be started, as shown between time T2 214 and T5 220. The HARQ RTT Timer may be started for the corresponding HARQ process.

At time T3 216, as shown at phantom arrow 216a, the HARQ RTT Timer may expire and the DRX Retransmission Timer 210 may be started. At time T4 218 the On Duration Timer expires. Because the DRX Inactivity Timer 208 and the DRX Retransmission Timer 210 have not expired, the UE still may be within the active time 202, and hence the UE may continue to monitor the PDCCH. If no new PDSCH packet is received between time T2 214 and T5 220, shown at phantom arrow 220a, then the DRX Inactivity Timer may expire at time T5 220. In this case, the UE may enter the DRX inactive time and stop monitoring the PDCCH until the next on duration defined by the short DRX cycle.

In an embodiment, a “CQI-mask” may be used to determine how to transmit the uplink CQI/PMI/RI during DRX. In particular, if the CQI-mask is set to “true,” then when the On Duration Timer is not running, the CQI/PMI/RI on the PUCCH may not be reported. Otherwise, when the CQI-mask is not set to “true,” or is set to “false,” then when not in active time, the CQI/PMI/RI on the PUCCH may not be reported.

FIG. 3 illustrates a periodic SRS transmission scheme, according to an embodiment of the present disclosure. In LTE, SRS 300 may be used by the eNB to measure the CQI for the uplink. The UE may transmit the SRS 300 periodically over time 302 in the uplink.

The eNB may configure the SRS transmission resources semi-statically via RRC signaling. Further, with a known symbol sequence modulated in the SRS, the eNB may measure the UE's timing drift. At a cell edge, the limited signal to noise ratio may require, or make desirable, using multiple SRS symbols with certain combinations of techniques to increase timing estimate accuracy. This periodic SRS transmission scheme is illustrated in FIG. 3. More details about the SRS may be found in 3GPP TS 36.213 v 9.0.1, physical layer procedures.

In view of the disclosures presented in FIG. 2 and FIG. 3, an issue regarding SRS transmissions may now be better understood. A purpose of the Release 9 CQI-mask described in FIG. 2 may be to allow efficient sharing of the uplink PUCCH resources for the CQI, the PMI and the RI. However, SRS transmissions during the DRX in Release 9 remain the same as in Release 8. In particular, Release 9 provides that the UE shall report the SRS only in active time. However, allowing reporting of SRS at any time during the active time may not always be a desirable method of SRS transmission during DRX. Because a UE may send SRS whenever the UE is active, periodic SRS transmissions may not be bound by the on-duration of the DRX cycle. As a result, an eNB may not be capable of time-sharing SRS resources in DRX. In many LTE systems, SRS resources may be limited, so sharing of SRS resources may be more desirable.

For a subset of the DRX cycles, such as in one embodiment 10 ms, 20 ms, 32 ms, 40 ms, 64 ms, 80 ms, 128 ms, and 160 ms, a possibility may exist that the only way to restrict periodic SRS transmission to the on-duration period is to set the periodicity of the SRS equal to the DRX cycle. However, this technique may limit the reporting activity to one SRS transmission per on-duration period. Further, for other DRX cycles, such as in one embodiment 256 ms, 320 ms, 512 ms, 640 ms, 1024 ms, 1280 ms, 2048 ms, and 2560 ms, a possibility may exist that the ability to time share SRS resources is not available.

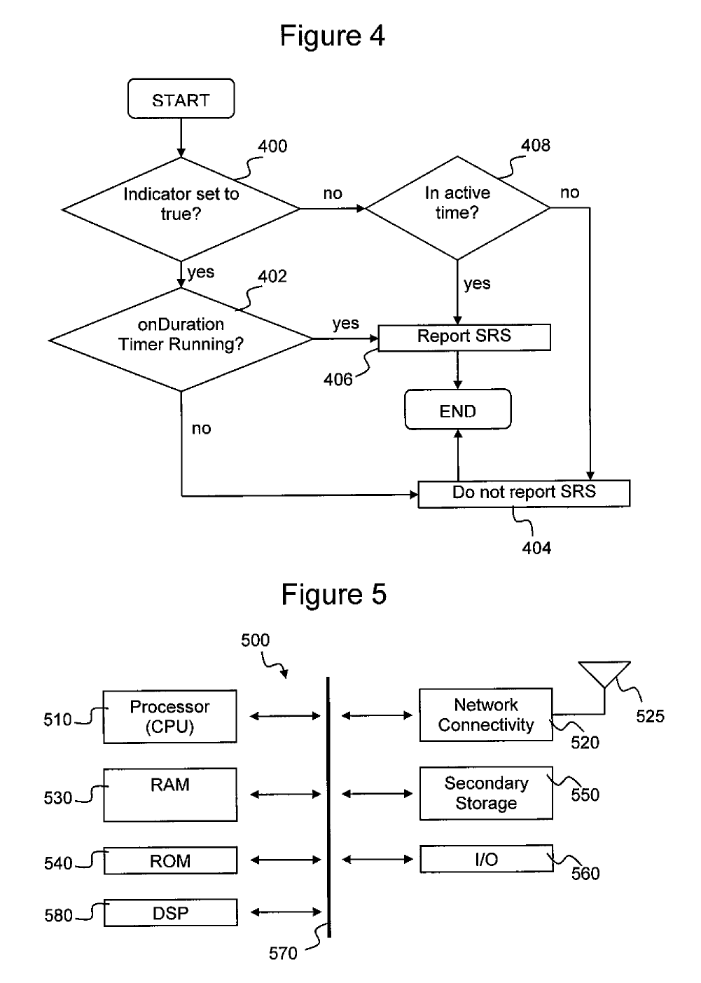

In one embodiment, a technique for addressing the above issues may be to use a specific indicator to indicate how the SRS are transmitted during DRX. For example, based on the indicator and when the On Duration Timer is not running, the SRS may not be reported. However, based on the indicator and when not in active time the SRS may not be reported. An example of this algorithm is shown in FIG. 4.

In another embodiment, this indicator may be a CQI-mask. In this case, an exemplary algorithm may be that if the CQI-mask is set to “true,” then when the On Duration Timer is not running, the SRS and CQI/PMI/RI on the PUCCH may not reported. In some cases, when the CQI-mask is set to “true,” and the On Duration Timer is running, the SRS and CQI/PMI/RI on the PUCCH may be reported. Otherwise, if the CQI mask is not set to “true,” such as being set to “false,” then when not in active time, the SRS and CQI/PMI/RI on the PUCCH may not be reported. In some cases, during active time when the CQI mask is set to “false,” the SRS and CQI/PMI/RI might be reported on the PUCCH. Thus, the SRS may be communicated on the PUCCH along with CQI/PMI/RI using the same algorithm given above for the CQI/PMI/RI. In other embodiments, the indicator may take different forms, and need not be tied to the CQI/PMI/RI.

These may embodiments have several benefits, for example, the embodiments described above provide for sharing of SRS resources during DRX. Such sharing may be more efficient in some embodiments. Additionally, the battery life of the UE may be extended when the CQI-mask is set to “true.” Other benefits may also exist.

FIG. 4 is a flowchart of a process for indicating how SRS are transmitted during DRX, according to an embodiment of the present disclosure. The process shown in FIG. 4 may be accomplished using the techniques described above with respect to FIG. 1 through FIG. 3. The process shown in FIG. 4 may be implemented in a user equipment, such as system 500 shown in FIG. 5.

The process begins as the UE determines whether an indicator is set to “true” (block 400). Where the indicator is set to “true,” then the UE also determines whether an On Duration Timer is running (block 402). Where the On Duration Timer is not running, then the UE does not report SRS (block 404). Alternatively and optionally, if the On Duration Timer is running at block 402, then the UE may report SRS (block 406). In either case, the process terminates thereafter.

Returning to block 400, if the indicator is not set to “true,” such as being set to “false,” then the UE determines whether it is in active time (block 408). If the UE is not in active time, then the UE does not report the SRS (block 404). If the UE is in active time, then optionally the UE may report the SRS (block 406). In either case, the process terminates thereafter.

While the embodiments described with respect to FIG. 1 through FIG. 4 have been characterized as not reporting a value, such as a SRS, CQI, PMI, or RI, under certain conditions, the embodiments may also be characterized as reporting one or more of these values only if certain conditions are satisfied. Thus, for example, one exemplary embodiment could be characterized as follows. If an indicator is set to “true,” then the SRS may be reported only when the On Duration Timer is running. However, if the indicator is not set to “true,” then the SRS may only be reported when in active time. Again, one exemplary indicator could be a CQI mask, though other indicators are possible.

The UE and other components described above might include processing and other components that alone or in combination are capable of executing instructions or otherwise able to promote the occurrence of the actions described above. FIG. 5 illustrates an example of a system 500 that includes a processing component, such as processor 510, suitable for implementing one or more embodiments disclosed herein. In addition to the processor 510 (which may be referred to as a central processor unit or CPU), the system 500 might include network connectivity devices 520, random access memory (RAM) 530, read only memory (ROM) 540, secondary storage 550, and input/output (I/O) devices 560. These components might communicate with one another via a bus 500. In some cases, some of these components may not be present or may be combined in various combinations with one another or with other components not shown. These components might be located in a single physical entity or in more than one physical entity. Any actions described herein as being taken by the processor 510 might be taken by the processor 510 alone or by the processor 510 in conjunction with one or more components shown or not shown in the drawing, such as a digital signal processor (DSP) 580. Although the DSP 580 is shown as a separate component, the DSP 580 might be incorporated into the processor 510.

The processor 510 executes instructions, codes, computer programs, or scripts that it might access from the network connectivity devices 520, RAM 530, ROM 540, or secondary storage 550 (which might include various disk-based systems such as hard disk, floppy disk, or optical disk). While only one CPU 510 is shown, multiple processors may be present. Thus, while instructions may be discussed as being executed by a processor, the instructions may be executed simultaneously, serially, or otherwise by one or multiple processors. The processor 510 may be implemented as one or more CPU chips.

The network connectivity devices 520 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 520 may enable the processor 510 to communicate with the Internet or one or more telecommunications networks or other networks from which the processor 510 might receive information or to which the processor 510 might output information. The network connectivity devices 520 might also include one or more transceiver components 525 capable of transmitting and/or receiving data wirelessly.

The RAM 530 might be used to store volatile data and perhaps to store instructions that are executed by the processor 510. The ROM 540 is a non-volatile memory device that typically has a smaller memory capacity than the memory capacity of the secondary storage 550. ROM 540 might be used to store instructions and perhaps data that are read during execution of the instructions. Access to both RAM 530 and ROM 540 is typically faster than to secondary storage 550. The secondary storage 550 is typically comprised of one or more disk drives or tape drives and might be used for non-volatile storage of data or as an over-flow data storage device if RAM 530 is not large enough to hold all working data. Secondary storage 550 may be used to store programs that are loaded into RAM 530 when such programs are selected for execution.

The I/O devices 560 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 525 might be considered to be a component of the I/O devices 560 instead of or in addition to being a component of the network connectivity devices 520.

The embodiments described herein may be implemented as computer readable instructions embodied on a computer readable medium, such as a non-transitory medium. Examples of such media include but are not limited to tangible memory, including RAM 530, ROM 540, or secondary storage 550, and possibly other tangible media such as hard disks, application specific integrated chips (ASICs), firmware, or any other suitable tangible media.

Thus, the embodiments provide a method implemented by a user equipment (UE). An indicator is read. One or more sounding reference signals (SRS) are not reported when the indicator is set to “true” and an On Duration Timer associated with a discontinuous reception (DRX) cycle is not running. One or more SRS are not reported when the indicator is not set to “true” and the UE is not in active time during the DRX cycle. The embodiments may also include a similar computer implemented method or a computer readable medium containing instructions to carry out such a method.

The embodiments also provide for a method implemented by a processor of a user equipment (UE) configured to report one or more sounding reference signals (SRS) during at least part of a discontinuous reception (DRX) cycle. An indicator is read. When the indicator is set to “true,” reporting the SRS occurs only when an On Duration Tinier associated with the DRX cycle is running. When the indicator is set to “false,” reporting the SRS occurs only when the UE is in active time during the DRX cycle.

The following 3GPP technical specifications are hereby incorporated by reference in their entireties: 36.213 and 36.321.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented by a user equipment (UE), the method comprising:
receiving an indicator;
not reporting one or more sounding reference signals (SRS) when the indicator is set to “true” and an On Duration Timer associated with a discontinuous reception (DRX) cycle is not running; and
not reporting the one or more SRS when the indicator is not set to “true” and the UE is not in active time during the DRX cycle.

2. The method of claim 1 wherein the indicator comprises a channel quality indicator (CQI) mask.

3. The method of claim 2 further comprising:
not reporting at least one of a channel quality indicator (CQI), a precoding matrix index (PMI), and a rank indicator (RI) when the indicator is set to “true” and the On Duration Timer is not running; and
not reporting at least one of the CQI, PMI, and RI when the indicator is not set to “true” and the UE is not in active time.

4. The method of claim 1 further comprising:
reporting the SRS when the indicator is set to “true” and the On Duration Timer is running; and
reporting the SRS when the indicator is not set to “true” and the UE is in active time.

5. The method of claim 4 wherein any reporting is transmitted on an uplink channel.

6. A computer readable medium comprising a tangible memory storing instructions which, when executed by a processor, implement a method comprising:
receiving an indicator;
not reporting one or more sounding reference signals (SRS) when the indicator is set to “true” and an On Duration Timer associated with a discontinuous reception (DRX) cycle is not running; and
not reporting the one or more SRS when the indicator is not set to “true” and the UE is not in active time during the DRX cycle.

7. The computer readable medium of claim 6 wherein the indicator comprises a channel quality indicator (CQI) mask.

8. The computer readable medium of claim 7 wherein the method further comprises:
not reporting at least one of a channel quality indicator (CQI), a precoding matrix index (PMI), and a rank indicator (RI) when the indicator is set to “true” and the On Duration Timer is not running; and
not reporting at least one of the CQI, PMI, and RI when the indicator is not set to “true” and the UE is not in active time.

9. The computer readable medium of claim 6 wherein the method further comprises:
reporting the SRS when the indicator is set to “true” and the On Duration Timer is running; and
reporting the SRS when the indicator is not set to “true” and the UE is in active time.

10. The computer readable medium of claim 9 wherein any reporting is transmitted on an uplink channel.

11. A user equipment (UE) comprising:
a processor configured to cause the UE to receive an indicator and not report one or more sounding reference signals (SRS) when the indicator is set to “true” and an On Duration Timer associated with a discontinuous reception (DRX) cycle is not running, and not report the SRS when the indicator is not set to “true” and the UE is not in active time during the DRX cycle.

12. The UE of claim 11 wherein the indicator comprises a channel quality indicator (CQI) mask.

13. The UE of claim 12 wherein the processor is further configured to cause the UE to:
not report at least one of a channel quality indicator (CQI), a precoding matrix index (PMI), and a rank indicator (RI) when the indicator is set to “true” and the On Duration Timer is not running; and
not report at least one of the CQI, PMI, and RI when the indicator is not set to “true” and the UE is not in active time.

14. The UE of claim 11 wherein the processor is further configured to cause the UE to:
report the SRS when the indicator is set to “true” and the On Duration Timer is running; and
report the SRS when the indicator is not set to “true” and the UE is in active time.

15. The UE of claim 14 wherein the processor is further configured to cause the UE to transmit any reporting on an uplink channel.
